(19) United States
(12) Patent Application Publication
(10) Pub. No.: US 2023/0104642 A1
(43) Pub. Date: Apr. 6, 2023

(54) Sensor Cleaning System and Vehicle having a Sensor Cleaning System

(71) Applicant: ZF CV Systems Global GmbH, Bern (CH)

(72) Inventors: Jan Cohrs, Wietzendorf (DE); Jan Fiebrandt, Hannover (DE); Janik Ricke, Uetze (DE)

(21) Appl. No.: 18/062,743

(22) Filed: Dec. 7, 2022

Related U.S. Application Data
(63) Continuation of application No. PCT/EP2021/068924, filed on Jul. 8, 2021.

(30) Foreign Application Priority Data
Jul. 23, 2020 (DE) 10 2020 119 473.0

(51) Int. Cl. B60S 1/56; B60S 1/54; B60S 1/50; B60S 1/52; F16K 11/044; F16K 27/00

(52) U.S. Cl. CPC B60S 1/56; B60S 1/54; B60S 1/50; B60S 1/52; F16K 11/044; F16K 27/003; F16K 2200/501

(57) ABSTRACT

The disclosure relates to a sensor cleaning system for a vehicle having: at least one sensor cleaning module, wherein the sensor cleaning module has a valve unit, wherein the valve unit is configured for receiving compressed air via a module compressed air port and for selectively outputting the compressed air cleaning pulse via a cleaning compressed air port. The sensor cleaning module has a module reservoir and a pump mechanism, wherein the module reservoir is configured for receiving and storing the cleaning liquid provided via a module liquid port, and is connected to the pump mechanism for fluid transfer, and the pump mechanism is configured for providing the cleaning liquid in the form of a liquid cleaning pulse at a cleaning fluid port depending on a control signal.

### CROSS-REFERENCE TO RELATED APPLICATIONS

This application is a continuation application of international patent application PCT/EP2021/068924, filed Jul. 8, 2021, designating the United States and claiming priority from German application 10 2020 119 473.0, filed Jul. 23, 2020, and the entire content of both applications is incorporated herein by reference.

### TECHNICAL FIELD

The disclosure relates in a first aspect to a sensor cleaning system and in a second aspect to a vehicle.

### BACKGROUND

Sensor cleaning systems, especially for vehicles, are well known. Such sensor cleaning systems must enable effective cleaning of vehicle sensors in the event of restrictions on installation space and weight in order to be able to ensure assistance systems and autonomous driving functions of the vehicle through clean sensors. In particular, the provision of a sufficient amount of cleaning liquid is problematic against the background of installation space and weight restrictions in a vehicle. It is also generally desirable to keep the equipment costs required for a sensor cleaning system low.

DE 101 10 490 A1 describes a device for controlling the supply of liquids in which it is provided that the liquid supply is divided into a working container and at least one storage container feeding the working container for refilling. With such an approach, a suitable use of installation space can be achieved and a large-volume supply of washing water can still be made available. However, such an approach results in relatively high system costs due to the large number of individual components. A relatively large central storage tank must also be kept in the vehicle.

Other approaches that take into account the problem of limited cleaning liquid in a vehicle are based on collecting rainwater. This is how DE 20 2017 100 529 U1 describes a rainwater collection system for a motor vehicle, comprising: a rain-water collector; a flap for the rainwater collector, wherein the flap can be moved between an open position and a closed position; and a controller configured to open or close the flap in response to a data entry regarding the detection of precipitation and a level of windshield washer liquid in a motor vehicle windshield washer system.

Other approaches that take into account the problem of a limited amount of cleaning liquid in a vehicle are based on the reuse of the cleaning liquid. Such an approach is described in US 2020/0010055 A1, which introduces a camera cleaning system with a collection container in which a cleaning liquid is collected after cleaning and can be reused. The camera cleaning system shown there has relatively large dimensions and the camera to be cleaned must be actively moved into a cleaning area by kinematics.

A similar approach is described in WO19029806 A1. With the system shown there, a cover is moved in front of the sensor during cleaning, which leads to the disadvantage that the function of the sensor is not available during cleaning. Such kinematics are also susceptible to faults.

Such approaches, based on the reuse of cleaning liquid, can delay refilling the system, but cannot completely avoid it.

In general, cleaning systems for cleaning sensors in vehicles still need to be improved, especially with regard to a configuration that takes into account the weight and installation space restrictions in a vehicle and at the same time enables the pro-vision of a sufficient amount of cleaning liquid.

Therefore, it is desirable to improve at least one of the mentioned disadvantages.

### SUMMARY

It is an object of the disclosure to specify an improved cleaning system that improves at least one of the disadvantages mentioned. In particular, the provision of cleaning liquid with improved use of the installation space in a vehicle is to be made possible in an economical manner.

The aforementioned object concerning the cleaning system is, for example, achieved by the disclosure in a first aspect with a cleaning system. The disclosure is based on a sensor cleaning system for a vehicle having:

at least one sensor cleaning module, wherein the sensor cleaning module has a valve unit, wherein

the valve unit is configured for receiving compressed air via a module compressed air port and for selectively outputting the compressed air cleaning pulse via a cleaning compressed air port.

According to the disclosure, it is provided in the sensor cleaning system that

the sensor cleaning module has a module reservoir and a pump mechanism, wherein

the module reservoir is configured for receiving and storing the cleaning liquid provided via a module liquid port, and which has a fluid conducting connected to the pump mechanism, and the pump mechanism is configured to provide the cleaning liquid in the form of the liquid cleaning pulse at a cleaning fluid port depending on a control signal.

The disclosure is based on the consideration that the provision of a sufficiently large amount of cleaning liquid in a sensor cleaning system of a vehicle is generally advantageous. Here, the disclosure has recognized that a decentralized arrangement with one or more sensor cleaning modules enables the improved management and provision of cleaning liquid, in particular under the operating and boundary conditions of a vehicle.

Because a sensor cleaning module has a module reservoir, cleaning liquid can be received and stored independently of a central reservoir. Thus, through the concept of a module reservoir, cleaning liquid or liquid can be stored decentrally, namely in the individual sensor cleaning modules, and output when necessary. In contrast to a relatively large central reservoir, a sensor cleaning module with a module reservoir can be arranged closer to a cleaning nozzle or a sensor to be cleaned due to the smaller installation space required, whereby the lines and thus the reaction times are advantageously shortened. An advantage of decentrally arranged module reservoirs is that the proximity between the module reservoir and the pump mechanism allows the cleaning liquid to be sucked in over relatively short distances. As a result, the sensor cleaning module and thus the sensor surface are supplied with cleaning liquid more quickly. At the same time, the risk of air being sucked into or entering the fluid system carrying cleaning liquid, in particular the nozzle liquid line, is reduced. Also, by a sensor cleaning system with sensor cleaning modules arranged close to the respective cleaning nozzles to be supplied, and the resulting shorter nozzle compressed air lines and/or nozzle liquid lines which can be implemented, pressure losses can be reduced, whereby the strongest possible cleaning pulses are advantageously achieved.

A pump mechanism can be broadly understood as a device for conveying and/or compressing liquid, in particular as a mechanical, hydraulic, pneumatic or electric pumping device. The control signal may be formed according to the type of pump mechanism, in particular as an electrical, pneumatic or mechanical control signal.

A sensor cleaning system according to the disclosure with at least one sensor cleaning module enables a decentralized architecture for decentralized collection of liquid and/or decentralized delivery of liquid, in particular since individual sensor cleaning modules can be arranged each with a module reservoir near both liquid sources and liquid consumers. Due to the modular configuration with sensor cleaning modules, a sensor cleaning system according to the disclosure is also suitable for retrofitting into an existing vehicle.

In the context of a development, it is provided that the pump mechanism is operated by compressed air, wherein the control signal is in the form of a compressed air control signal, and the valve unit is configured for the selective output of the compressed air control signal via a control compressed air port. Such a development includes the realization that a compressed air-operated pump mechanism is an advantageous possibility for the selective provision of a liquid cleaning pulse, since in particular the number of hydraulic valves and similar switching means for switching liquids, which are usually relatively cost-intensive and prone to faults, can be advantageously reduced. Via a compressed air-operated pump mechanism, the selective provision of a liquid cleaning pulse can advantageously be carried out with the switching of compressed air flows, in particular of a compressed air control signal via the switching valve. A compressed air-operated pump mechanism can be advantageously used in a sensor cleaning system according to the disclosure with sensor cleaning modules arranged close to the respective cleaning nozzles to be supplied, since the resulting shorter nozzle liquid lines which can be implemented result in a relatively low pressure loss of the generated liquid cleaning pulses.

In the context of a development, it is provided that the compressed air-operated pump mechanism has a piston with an air chamber and a liquid chamber, which are separated from each other in a fluid-tight manner by an axially movable plunger. The plunger is connected to a housing of the piston with a return spring, wherein the return spring is deflected from its resting position against a resting force in the event of pressurization of the air chamber to output the liquid cleaning pulse and relaxes again when the pressure drops to suck in the cleaning liquid.

In the context of a development, it is provided that the sensor cleaning module has a module control unit which is configured for controlling the valve unit, in particular depending on a control signal provided by a vehicle control unit of the vehicle and/or that the sensor cleaning system has a device control unit which is configured for controlling the valve units of at least one, in particular all, sensor cleaning modules of the sensor cleaning system, in particular depending on a control signal provided by a vehicle control unit of the vehicle. In developments in which a sensor cleaning module has a module control unit, a sensor cleaning module has a certain degree of autonomy and can communicate, in particular with other sensor cleaning modules and/or with a vehicle control unit. In developments in which the sensor cleaning system has a device control unit, the individual sensor cleaning modules can be controlled centrally. In developments in which the sensor cleaning system has no module control unit and no device control unit, the valve units of the sensor cleaning modules can be controlled directly by a vehicle control unit.

In the context of a development, at least one cleaning nozzle with an air conducting and/or fluid conducting connection to the sensor cleaning module is provided, which is configured for applying a liquid cleaning pulse and/or a compressed air cleaning pulse to a sensor surface. In particular, a number of several cleaning nozzles may be connected to a sensor cleaning module. In particular, a cleaning nozzle may be provided for a sensor surface.

In the context of a development, at least one further sensor cleaning module is provided, wherein the sensor cleaning module and the at least one further sensor cleaning module have a bidirectional fluid conducting connection via an exchange line and/or have a bidirectional signal conducting connection via a control line.

The additional sensor cleaning module or modules each have an additional module reservoir for storing cleaning liquid. In developments with two or more sensor cleaning modules, the decentralized architecture of the sensor cleaning system can be advantageously used, in particular the decentralized storage of cleaning liquid and exchange of cleaning liquid between the sensor cleaning modules. Also, sensor cleaning modules can be advantageously arranged in the vicinity of the sensors to be cleaned, which reduces the line lengths between the sensor cleaning module and cleaning nozzles and in particular reduces the reaction time and pressure losses, because the cleaning pulses travel a shorter distance.

In the context of a development, it is provided that the sensor cleaning module is assigned to a first sensor cluster arranged in particular in the front area of the vehicle with a number of collocated cleaning nozzles for at least one, in particular for each, sensor, and that further the sensor cleaning module is assigned to a second cluster, in particular arranged in the rear area of the vehicle, with a number of collocated cleaning nozzles for at least one sensor, in particular for each sensor. “Collocated” means in particular that distance and/or line length of the line or the lines between a sensor cleaning module and the associated cleaning nozzles, in particular the line length of the nozzle liquid line and/or the nozzle compressed air line, is less than 1 m, preferably less than 50 cm. In other developments, sensor cleaning modules can be provided to supply other or additional clusters of collocated cleaning nozzles.

In the context of a development, it is provided that of the module control unit of the sensor cleaning module and another module control unit of the further sensor cleaning module, one module control unit has a priority position in such a way that—in particular in the case of a limited amount of cleaning liquid that is not sufficient for both sensor cleaning modules—the sensor cleaning module with a module control unit with the priority position has access to the cleaning liquid stored in the module reservoir of the other sensor cleaning module. A priority position of a sensor cleaning module can be implemented in particular by the module control units or a vehicle control unit of the vehicle, so that one or more sensor cleaning modules with no priority are switched off or not activated by the module control units or the vehicle control unit. The sensor cleaning module with a priority position is assigned in particular to one or more sensors that are responsible for critical driving functions, that is, essential for the functioning of the vehicle.

In the context of a development, it is provided that the module reservoir has a fluid conducting connection to at least one liquid source, in particular a windscreen wiper liquid tank, a fuel cell, a rain collection device, a cooling system, an air dryer and/or another sensor cleaning module. In advantageous developments, the module reservoir of the sensor cleaning module has a fluid conducting connection to several liquid sources in order to ensure the highest possible availability of cleaning liquid. In particular, liquid sources which gain liquid during the operation of the vehicle are advantageous for high availability of cleaning liquid. Such liquid sources include components of the vehicle which can obtain cleaning liquid, for example by collecting rain and/or spray water, or by producing condensation. In the simplest case, water can be used as a cleaning liquid. Due to such liquid sources, the time interval until a necessary filling of a liquid tank can be advantageously extended or a refill of a liquid tank may even be completely dispensed with. In particular, the sensor cleaning module is arranged lower than the liquid source. This means that the liquid source—considered vertically, in particular perpendicular to the road surface—is arranged higher than the sensor cleaning module with the module reservoir. In developments in which the sensor cleaning module is arranged lower than the liquid source, gravity can be advantageously used to fill the module reservoir, in particular a pump or a similar means of conveyance for providing the cleaning liquid for the module reservoir can be dispensed with.

In the context of a development, a pump configured for conveying the cleaning liquid is provided, which is arranged in a liquid supply line or an exchange line—which fluid-conductively connects the sensor cleaning module to at least one liquid source. Such a pump is advantageous in developments in which there is a height difference between a liquid source and a sensor cleaning module (or between two sensor cleaning modules), and the cleaning liquid must be conveyed against the direction of gravity.

In the context of a development, it is provided that at least two cleaning nozzles, preferably at least three cleaning nozzles, are assigned to a sensor cleaning module. Several cleaning nozzles can be advantageously supplied by a sensor cleaning module, in particular if they are collocated.

In the context of a development, it is provided that the cleaning nozzle is arranged separately from the sensor cleaning module. In such developments, the cleaning nozzles can be connected to the sensor cleaning module via supply lines, in particular via a liquid nozzle line and/or a compressed air nozzle line.

In the context of a development, it is provided that a line length between the sensor cleaning module and at least one, in particular all, cleaning nozzles connected to the sensor cleaning module is less than 80 cm, preferably less than 50 cm.

In the context of a development, it is provided that the sensor cleaning module has a module compressed air reservoir, configured for receiving and locally storing the compressed air provided via the module compressed air port. A module compressed air reservoir preferably has a capacity between 20 ml and 60 ml, more preferably 40 ml. A module compressed air reservoir advantageously reduces the dependence on a compressed air source, especially if no compressed air is temporarily available, for example if a compressor is not yet conveying air after a longer downtime of the vehicle.

In the context of a development, it is provided that the module reservoir of the sensor cleaning module has a capacity between 250 ml and 3000 ml, preferably between 250 ml and 1000 ml. A larger capacity increases the availability of cleaning liquid. A lower capacity allows a more compact configuration of the sensor cleaning module and thus a better arrangement of the sensor cleaning module near the sensors to be cleaned.

In the context of a development, it is provided that the sensor cleaning module is arranged and/or configured to utilize waste heat of a heat source of the vehicle, in particular has a heating device. In particular, the sensor cleaning module is adjacent to a heat source, in particular to a combustion engine or fuel cell, or is mechanically connected to a heat source via a thermally conductive component.

In the context of a development, it is provided that the sensor cleaning module has a module housing surrounding the sensor cleaning module, in particular made of plastic or aluminum or cast aluminum. The module housing is formed in particular from a valve cartridge housing, with first to third valve inserts, wherein each valve insert is assigned a switching valve in the form of a cartridge valve arranged in the valve insert. The module housing is formed in particular from a material with sufficient mechanical and thermal stability. The module housing can have a number of valve inserts for the switching valves and space for other components of the sensor cleaning module. In particular, the switching valve may be fully or partially in the form of one or more switching valves in the form of cartridge valves. In particular, the compressed air-operated pump mechanism may be completely or partially in the form of one or more switching valves in the form of cartridge valves, wherein the switching valves in the form of cartridge valves are configured in particular for activating a pressure cylinder.

The switching valve is in the form in particular of a 2/2-way valve, preferably of a 2/2-way solenoid valve. The valve cartridge housing is preferably a standard valve cartridge housing, in particular a standard pneumatic or hydraulic or fluidic component, for example for an axle modulator or a brake control unit.

In such developments, in which a valve cartridge housing forms the housing of the sensor cleaning module, the advantage of a space-saving integration is further enhanced, whereby better positioning near the nozzle and a generally decentralized arrangement of the modules are also achieved in an improved manner. Cost savings are also advantageously achieved through the use of cartridge valves as standard components. The use of a valve cartridge housing as a module housing with suitable cartridge valves also has the advantage that relatively large nominal diameters of the valves can be realized in a relatively small installation space, which results in an improved flow of the media, in particular an improved air flow. A valve cartridge housing is formed in particular as a block in which a number of valve inserts are introduced by suitable processing methods with corresponding bores or similar air conducting and/or fluid conducting lines between the valve inserts and/or external ports. A module reservoir may be arranged in particular in the valve cartridge housing or attached to it.

In an advantageous development, all switching valves of a sensor cleaning module in the form of, in particular identical, cartridge valves. A cartridge valve can be used in particular advantageously both as a 2/2-way valve or a 3/2-way valve, in particular by adjusting the valve insert, that is by providing a corresponding number of ports in the valve insert.

In particular, the development has a suction pressure check valve, which is arranged in particular at the liquid cleaning port and is configured to block a flow against the direction of the liquid cleaning pulse.

In particular, in developments with valve bodies with a sealing ring sealing only on one side, at least one check valve per switching valve is provided. In the context of a development with a housing in the form of a valve cartridge housing, a fourth valve insert with a fourth switching valve in the form of a cartridge valve and/or a fifth valve insert with a fifth switching valve in the form of a cartridge valve is provided. The fourth and fifth switching valves are each configured in particular for the selective switching of one or more cleaning nozzles.

In the context of a development with a housing in the form of a valve cartridge housing, it is provided that the valve inserts are approximately of hollow cylindrical form and the switching valves in the form of a cartridge valve each have a valve body with at least a first and a second axially adjacent valve chamber, which are pneumatically separated at least in one flow direction by a sealing ring bearing against an inner wall of the valve insert in a pressure-tight manner. Preferably, the sealing ring is in the form of a sealing ring blocking on both sides, in particular as an O-ring blocking on both sides. In particular, the sealing ring for all switching valves is in the form of a sealing ring blocking on both sides. “Blocking on both sides” means that neither a flow from the first to the second valve chamber, nor from the second to the first valve chamber is permitted.

In the context of a development with a housing in the form of a valve cartridge housing, the pump mechanism including a piston is integrated into the module housing.

In the context of a development with a housing in the form of a valve cartridge housing, a heating wire is provided as a heating device, which is supplied and/or controlled in particular by the module control unit.

In the context of a development, a pressure sensor and/or a position sensor is provided. The position sensor is particularly configured for determining a position of a plunger of the piston, wherein the plunger is axially movable in the piston for variable separation of an air chamber and a liquid chamber. A pressure sensor may be provided in particular on the air chamber of the piston of the pump mechanism.

In particular, it is provided that a capacity of the module reservoir is a multiple, in particular a tenfold, of a piston volume of a piston of the pump mechanism.

In a second aspect, the disclosure for solving the object further specifies a vehicle, in particular a passenger car or commercial vehicle or trailer, having a sensor cleaning system according to the first aspect of the disclosure. In the vehicle according to the second aspect of the disclosure, the advantages of the sensor cleaning system according to the first aspect of the disclosure are advantageously used.

### BRIEF DESCRIPTION OF DRAWINGS

The invention will now be described with reference to the drawings wherein:

FIG. 1 shows a schematic illustration of a vehicle with a sensor cleaning system according to the disclosure;

FIG. 2 shows a vehicle in the form of a passenger car with a sensor cleaning system according to the disclosure;

FIG. 3 shows a vehicle in the form of a passenger car with a sensor cleaning system which has three different liquid sources by way of example;

FIG. 4 shows a vehicle in the form of a passenger car with a sensor cleaning system which has a sensor cleaning module 200 and another sensor cleaning module;

FIG. 5 shows the vehicle shown in FIG. 2 in a side view;

FIG. 6 shows a vehicle in the form of a commercial vehicle with a sensor cleaning system according to the disclosure;

FIG. 7 shows a combination of a vehicle which has a trailer in addition to the commercial vehicle already shown in FIG. 6;

FIG. 8 shows schematically a configuration of a sensor cleaning module with a module housing, which is in the form of a valve cartridge housing;

FIG. 9 shows parts of a module housing in the form of a valve cartridge housing in a sectional illustration;

FIGS. 10A, 10B show an embodiment of a switching valve in the form of a 2/2-way valve in a sectional view;

FIGS. 11A, 11B show a further embodiment of a switching valve in the form of a 3/2-way valve;

FIG. 12 shows a further embodiment of a sensor cleaning module which, in contrast to the embodiment shown in FIG. 8, has a valve body which has an O-ring which seals on both sides instead of the sealing ring which only seals on one side;

FIG. 13 shows a further embodiment of a sensor cleaning module which has a heating device in the form of a heating wire in contrast to the sensor cleaning module illustrated in FIG. 12; and,

FIG. 14 shows a further embodiment of a sensor cleaning module which has two further switching valves, namely a fourth switching valve and a fifth switching valve, in contrast to the sensor cleaning module illustrated in FIG. 12.

### DETAILED DESCRIPTION

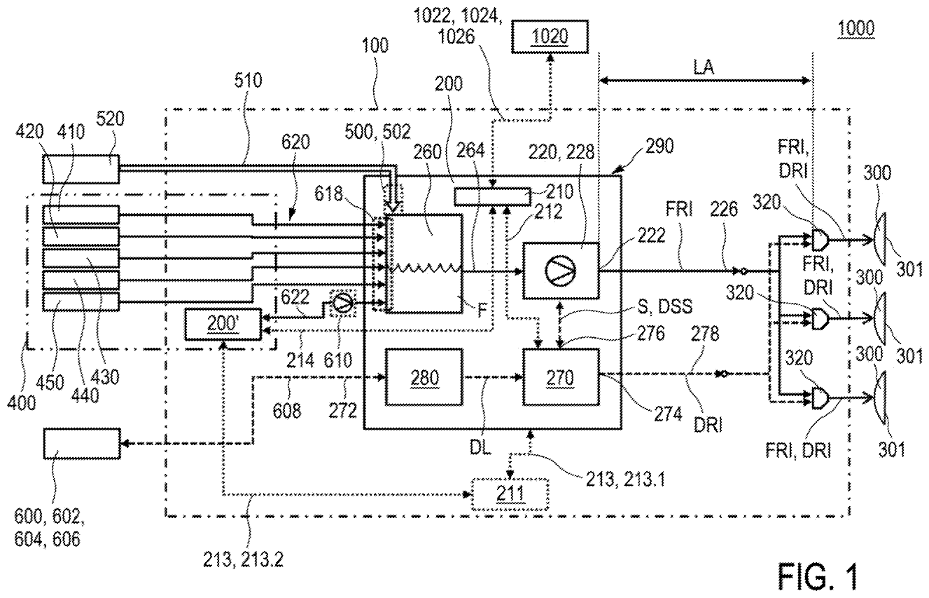

FIG. 1 shows a schematic illustration of a vehicle 1000 with a sensor cleaning system 100 according to the disclosure. The vehicle 1000 is simplified in such a way that only the parts relevant to the sensor cleaning system 100 are shown.

The sensor cleaning system 100 has at least one sensor cleaning module 200. The sensor cleaning module 200 is configured to supply one or more cleaning nozzles 320 with compressed air DL in the form of compressed air cleaning pulses DRI and/or cleaning liquid F in the form of liquid cleaning pulses FRI. In the present case, three cleaning nozzles 320 are shown, each of which is assigned to a sensor surface 300 of a sensor 301. Nevertheless, embodiments are possible in which several cleaning nozzles 320 are assigned to a sensor surface 300, or a cleaning nozzle 320 to several sensor surfaces 300.

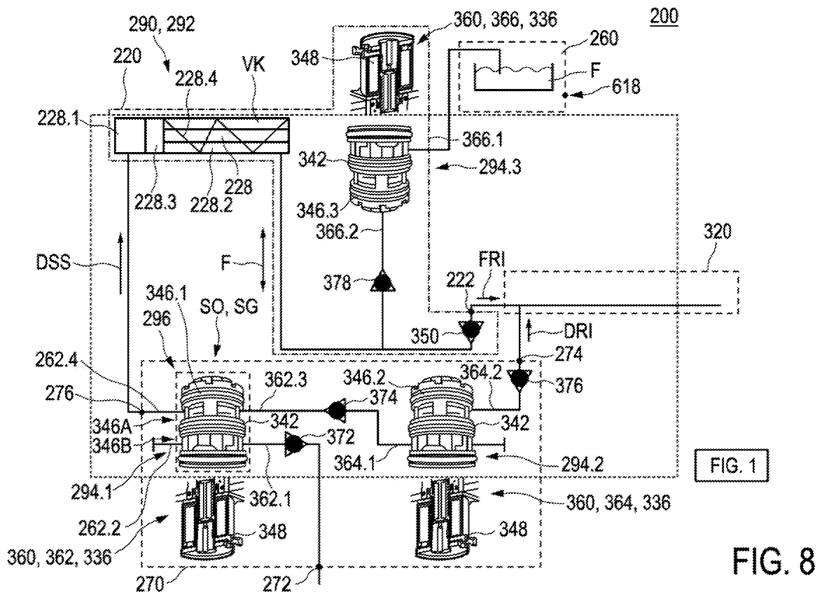

The sensor cleaning module 200 has a pump mechanism 220 in the form of a compressed air-operated pump mechanism with a piston 228, which is configured to receive cleaning liquid F from a module reservoir 260 via a storage line 264 and—on the basis of a control signal S provided by a valve unit 270 in the form of a compressed air control signal DSS—to provide cleaning liquid F to the cleaning nozzle 320 in the form of a liquid cleaning pulse FRI via a cleaning liquid port 222 and a nozzle liquid line 226. The pump mechanism is in particular identical to the pump mechanism shown in FIG. 8, which is why reference is made to FIG. 8 for the more detailed functionality. In other embodiments, the pump mechanism may be in another form, for example of an electric pump or a similar conveying device.

The valve unit 270 of the sensor cleaning module 200 is further configured to provide compressed air DL provided via a module compressed air port 272 to the cleaning nozzle 320 in the form of a compressed air cleaning pulse DRI via a cleaning compressed air port 274 and a nozzle compressed air line 278.

The valve unit 270 can thus provide on the one hand a compressed air cleaning pulse DRI via the cleaning compressed air port 274, and on the other hand can provide a compressed air control signal DSS for controlling the pump mechanism 220 via a control compressed air port 276.

The valve unit 270 has a number of switching valves not illustrated here in detail which are controlled via a module control unit 210. For this purpose, the module control unit 210 is electronically connected signal conductively to the valve unit 270 via a module control line 212.

In alternative embodiments, alternatively or additionally a device control unit 211 can optionally be provided, which has a signal conductive connection via a device control line 213, in this case via a first device control line 213.1 and a second device control line 213.2, to the valve units 270, 270′ of the individual sensor cleaning modules 200, 200′ for control purposes, in particular depending on a control signal 1022 provided by a vehicle control unit 1020 of the vehicle 1000.

The module reservoir 260 is configured for storing the cleaning liquid F and has at least one module liquid port 618 for receiving new cleaning liquid F. The cleaning liquid F stored in the module reservoir 260 can be passed via the storage line 264 to the pump mechanism 220.

The module liquid port 618 is fluid conductively connected via at least one liquid supply line 620 to a liquid source 400. One or more of the following components shown here can serve as a liquid source 400: a windshield wiper liquid tank 410, a fuel cell 420, a rain collection device 430, a cooling system 440, an air dryer 450 and/or one or more other sensor cleaning modules 200′. Other components of a vehicle in which liquid is obtained or is produced as a by-product can be advantageously used as a liquid source 400 in the context of the disclosure. In particular, in the context of the disclosure, different sensor cleaning modules 200, 200′ of a sensor cleaning system 100 may each be connected to different types of liquid sources 400. Also, in the context of the disclosure in a sensor cleaning system 100, a first set of sensor cleaning modules 200 are connected to liquid sources 400 and a second set of sensor cleaning modules 200 are connected to cleaning nozzles 320, so that the first set are configured for supplying cleaning liquid F and the second set are configured for cleaning sensor surfaces 300.

The present liquid supply line 620 leading to the further sensor cleaning module 200′ is in the form of a bidirectional exchange line 622. This advantageously enables an exchange of cleaning liquid F between individual sensor cleaning modules 200, 200′ if required. The exchange line 622 can optionally have a pump 610 for conveying the cleaning liquid F. The pump 610 may be configured for conveying the cleaning liquid F in one or both directions.

The sensor cleaning module 200 can optionally have a module compressed air reservoir 280 for the local storage of compressed air DL in the sensor cleaning module 200. For this purpose, the module compressed air reservoir 280 can be pneumatically arranged between the module compressed air port 272 and the valve unit 270.

Compressed air DL can be provided at the module compressed air port 272 by a compressed air source 600, in particular a compressor 602 or a central compressed air reservoir 604 of a compressed air supply system 606.

The sensor cleaning module 200 can optionally have a heating device 500. The heating device 500 may be formed, for example, by a heat exchanger 502, which is configured to absorb waste heat 510 of a heat source 520. A combustion engine of the vehicle 1000 can serve as a heat source 520 for example. The heat exchanger 501 can be formed in the simplest case by a surface onto which waste heat 510 flows or in contact with the heat source 520. Also, the heating device 500 may be in the form of an electric heating device with one or more heating wires.

The module control unit 210 has a signal conductive connection via a central control line 1024 to a vehicle control unit 1020, in particular for the transmission of a control signal 1022. The central control line 1024 may be in particular in the form of a vehicle bus 1026 or part of a vehicle bus 1026.

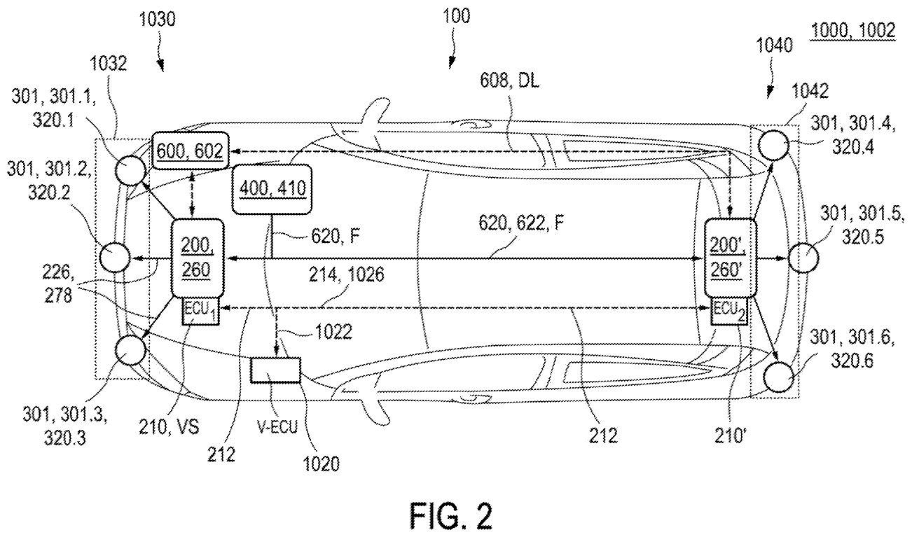

FIG. 2 shows a vehicle 1000 in the form of a passenger car 1002 with a sensor cleaning system 100 according to the disclosure. The sensor cleaning system 100 has a sensor cleaning module 200 in a front area 1030 of the vehicle 1000 for the supply of a front cluster 1032 of cleaning nozzles 320. The cleaning nozzles 320 of the front cluster 1032 are arranged locally, namely in the front area 1030 of the vehicle 1000. The front cluster 1032 includes a first cleaning nozzle 320.1 for cleaning a first sensor 301.1, a second cleaning nozzle 320.2 for cleaning a second sensor 301.2 and a third cleaning nozzle 320.3 for cleaning a third sensor 301.3. Since the cleaning nozzles 320.1, 320.2, 320.3 are collocated in a cluster, they can be advantageously commonly supplied by a sensor cleaning module 200, in particular because a nozzle liquid line 226 and a nozzle compressed air line 278 can be kept sufficiently short.

The sensor cleaning system 100 has a further sensor cleaning module 200′ in a rear area 1040 of the vehicle 1001 for the supply of a rear cluster 1042 of cleaning nozzles 320. The cleaning nozzles 320, namely a fourth cleaning nozzle 320.4 for cleaning a fourth sensor 301.4, a fifth cleaning nozzle 320.5 for cleaning a fifth sensor 301.5 and a sixth cleaning nozzle 320.6 for cleaning a sixth sensor 301.6, are collocated, namely in the rear area 1040.

A module control unit 210 of the sensor cleaning module 200 and another module control unit 210′ of the further sensor cleaning module 200′ each have a signal conductive connection via a module control line 212 to a vehicle controller 1020, in particular for the transmission of a control signal 1022. Furthermore, the module control unit 210 and the further module control unit 210′ are signal conductively connected via a module communication line 214. The module control line 212 and/or the module communication line 214 may be in the form of part of the vehicle bus 1026.

The vehicle 1000 also has a windscreen wiper liquid tank 410 as a liquid source 400, which is fluid conductively connected to the sensor cleaning module 200 and the sensor cleaning module 200′ via a liquid supply line 620 for providing a cleaning liquid F.

Furthermore, the sensor cleaning module 200 and the further sensor cleaning module 200′ are fluid conductively connected to each other via an exchange line 622 for exchanging cleaning liquid F. The liquid supply line 620 and the exchange line 622 may be partially or completely in the form of a common line.

The vehicle 1000 also has a compressor 602 as a compressed air source 600 for supplying the sensor cleaning module 200 and the further sensor cleaning module 200′ with compressed air DL via a compressed air line 608.

Furthermore, FIG. 2 shows by way of example a priority position VS for the module control unit 210, which gives the sensor cleaning module 200 priority relative to the other sensor cleaning module 200′. This means that with a limited supply of cleaning liquid F, the sensor cleaning module 200 is preferably supplied with this, and thus can also obtain the cleaning liquid F stored in the further module reservoir 260′ of the further sensor cleaning module 200′ via the exchange line 622. The sensor cleaning system 100 may be configured in particular such that a less prioritized sensor cleaning module 200, in particular a sensor cleaning module 200 without a priority position VS, is switched off and/or not activated if there is only a small amount of cleaning liquid still present in the liquid source 400.

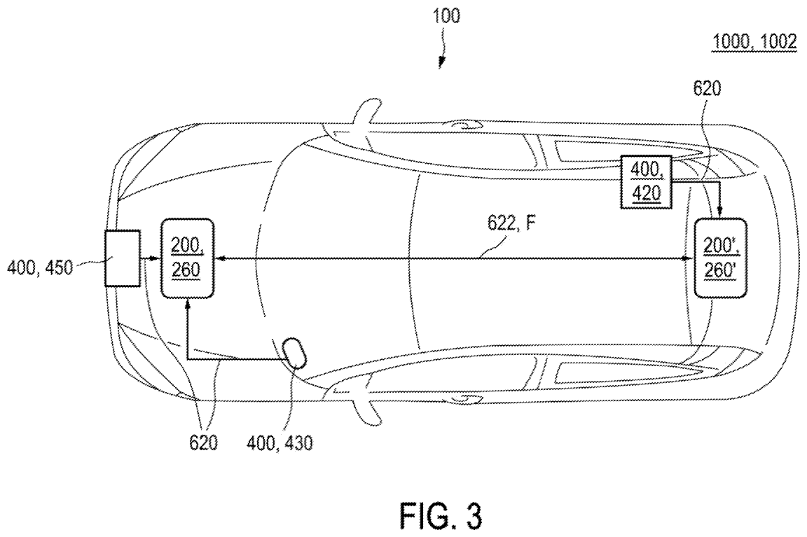

FIG. 3 shows a vehicle 1000 in the form of a passenger car 1002 with a sensor cleaning system 100, which has by way of example three different liquid sources 400. It should be clear that in the context of the disclosure also further and/or different liquid sources 400 can be used in a sensor cleaning system 100. In particular, the decentralized architecture of the sensor cleaning system 100 with sensor cleaning modules 200, 200′ advantageously allows the integration and use of several different liquid sources 400 for the advantageous collection of liquid and cleaning liquid F, wherein the cleaning liquid F can be exchanged between the sensor cleaning modules 200, 200′ via exchange lines 622. A cleaning liquid F can be in the form of water in the simplest case, for example rainwater or condensation.

In the present case, the vehicle 1001 has a sensor cleaning module 200, which is connected via a liquid supply line 620 to a liquid source 400 in the form of an air dryer 450. The air dryer 450 may in particular be part of a compressed air supply system. During the operation of the compressed air supply system, in particular during regeneration, condensation accumulates in the air dryer 450 which is advantageously stored in a module reservoir 260 (not illustrated here) of the sensor cleaning module 200 and can be used as cleaning liquid F in the sensor cleaning system 100.

The sensor cleaning module 200 is further fluid conductively connected via a liquid supply line 620 to a rain collection device 430 as a liquid source 400. Rainwater can be collected when it rains by the rain collection device 430 and stored in the module reservoir 260 of the sensor cleaning module 200.

The sensor cleaning system 100 has a further sensor cleaning module 200′, which is fluid conductively connected via a liquid supply line 620 to a liquid source in the form of a fuel cell 420. During the operation of the fuel cell 420, which primarily serves the drive of the vehicle 1000, is water is produced during operation, which can be advantageously stored in another module reservoir 260′ (not illustrated here) of the further sensor cleaning module 200′ and made available to the sensor cleaning system 100 as cleaning liquid F.

The sensor cleaning module 200 and the further sensor cleaning module 200′ are fluid conductively connected to each other via an exchange line 622 for the exchange of cleaning liquid F. In this way, a sensor cleaning module 200, 200′ can be advantageously supplied by another sensor cleaning module 200, 200′ if the other sensor cleaning module 200, 200′ has an excess of cleaning liquid F available. For example, in the event of persistent rain and when the module reservoir 260 of the sensor cleaning module 200 is already completely filled, the additional module reservoir 260′ of the further sensor cleaning module 200′ can be filled via the exchange line 622. The same applies to the other liquid sources 400.

Due to the possibility of a decentralized arrangement of the sensor cleaning modules 200, 200′, therefore, the largest possible number of liquid sources 400 can be integrated into the sensor cleaning system 100 and thus the availability of cleaning liquid F can be advantageously increased.

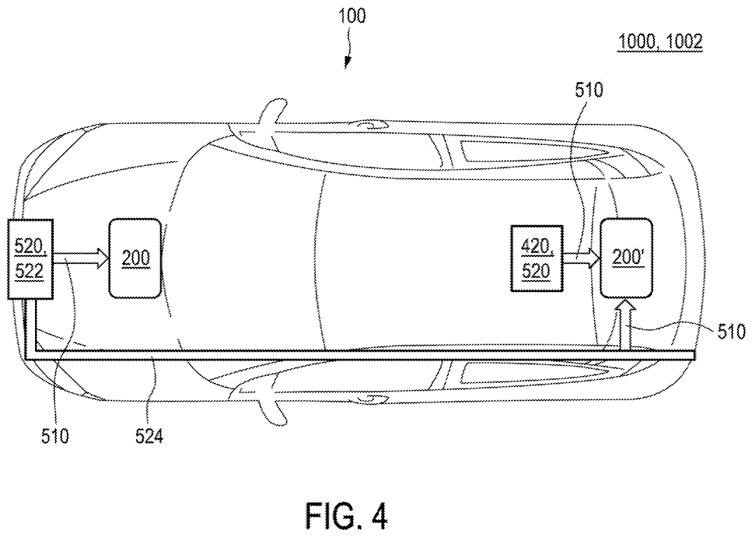

FIG. 4 shows a vehicle 1000 in the form of passenger car 1002 with a sensor cleaning system 100 which has a sensor cleaning module 200 and another sensor cleaning module 200′. Here by way of example, different heat sources 520 are illustrated to clarify the concept of the use of waste heat 510. Waste heat 510 can arise in different components of a vehicle 1000 and can be advantageously used to heat the cleaning liquid F, in particular if outside temperatures are around or below the freezing point. Also, especially in the case of contamination of the sensor surface with greases and oils, the cleaning performance improves with a heated cleaning liquid F. One or more of the heat sources 520 shown here or further heat sources 520 can of course be combined with other embodiments shown here.

The sensor cleaning module 200 is arranged in the vehicle in such a way that it receives waste heat 510 from a heat source 520 in the form of a combustion engine 522. For this purpose, it may be sufficient that the sensor cleaning module 200 is arranged near the heat source 520, in particular the combustion engine 522. In other embodiments, the sensor cleaning module 200 may be arranged directly adjacent to the heat source 520, in particular to the combustion engine 522, or mechanically connected to the heat source 520, in particular the combustion engine 522, via a suitable thermally conductive component.

The further sensor cleaning module 200′ receives waste heat 510 in a similar manner from a heat source 520 in the form of a fuel cell 420. By arranging the further sensor cleaning module 200′ near the fuel cell 420, this waste heat 510 generated during the operation of the fuel cell 420 can be used to heat cleaning liquid F.

Alternatively or additionally, a sensor cleaning module 200—as shown here with the further sensor cleaning module 200′—can obtain waste heat 510 via an exhaust system 524 of the combustion engine 522. For this purpose, the sensor cleaning module 200, 200′ may be arranged near the exhaust system 524 to be affected by an exhaust gas flow of the exhaust system 544. Nevertheless, heat transfer via a heat-transferring component and/or a heat exchanger is also possible here.

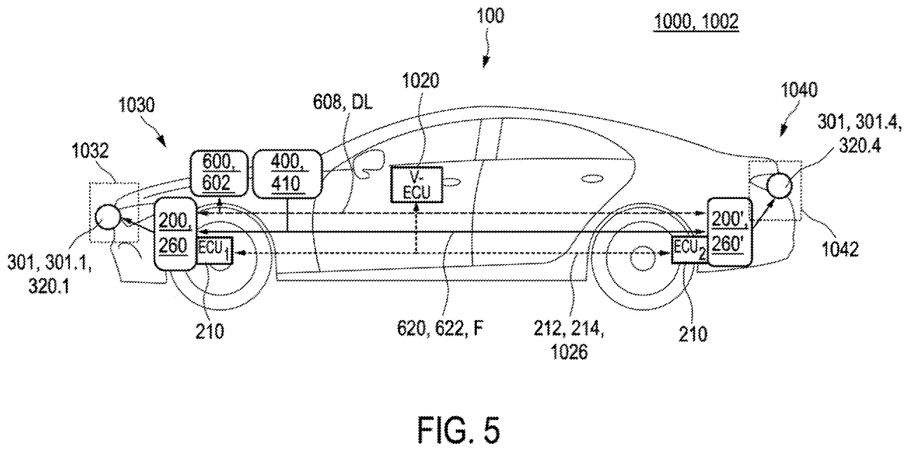

FIG. 5 illustrates the vehicle 1000 shown in FIG. 2 in a side view. It can be seen that the liquid source 400, here the windshield wiper liquid tank 410, is arranged above the sensor cleaning modules 200, 200′. By this arrangement, the module reservoir 260 (not shown here) of the sensor cleaning module 200 and the further module reservoir 260′ (also not shown) of the further sensor cleaning module 200′ can be filled advantageously using gravity, since the cleaning liquid F present in the windshield wiper liquid tank 410 flows downwards via the liquid supply lines 620 into the module reservoirs 260, 260′ automatically, in particular without a pump 610 or a similar conveying device.

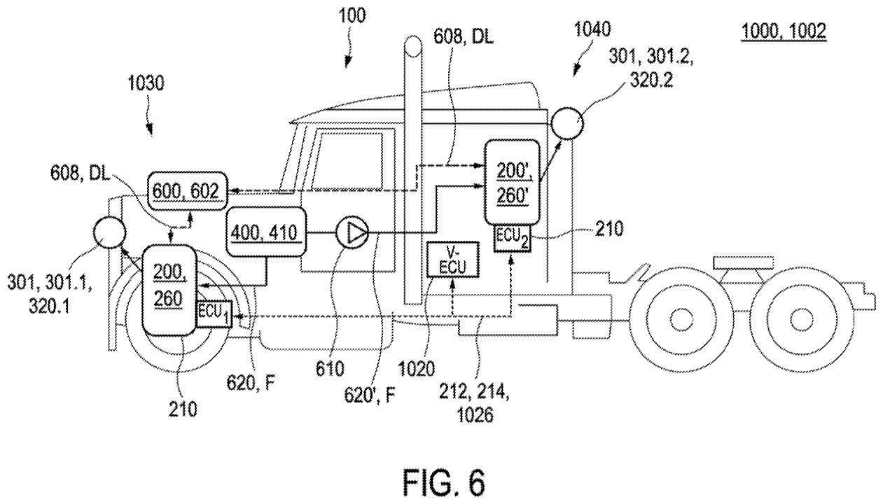

FIG. 6 shows a vehicle 100 in the form of a commercial vehicle 1004 with a sensor cleaning system 100 according to the disclosure. The sensor cleaning system 100 has a sensor cleaning module 200, which is arranged to supply a first cleaning nozzle 320.1 arranged in the front area 1030 of the vehicle 1000 for cleaning a first sensor 301.1. Nevertheless, further cleaning nozzles 320 in the front area 1030, in particular for cleaning further sensors 301, can be connected to the sensor cleaning module 200 for supply.

The sensor cleaning system 100 has another sensor cleaning module 200′ for supplying a second cleaning nozzle 320.2 arranged in the rear area 1040 of the vehicle 1000. The second cleaning nozzle 320.2 is used in particular for cleaning a second sensor 301.2. Nevertheless, further cleaning nozzles 320.2, in particular for cleaning further sensors 301, can be connected to the further sensor cleaning module 200′. Furthermore, collocated sensors 301 can be combined into clusters that are supplied by a sensor cleaning module 200 (not illustrated here).

Both sensor cleaning modules 200, 200′ are supplied with cleaning liquid F by a liquid source 400 in the form of a windscreen wiper liquid tank 410. A windscreen wiper liquid tank 410 may have a capacity of a few liters, in particular in a commercial vehicle from 10 L to 15 L. The sensor cleaning module 200 is arranged below the windscreen wiper liquid tank 410, so that the cleaning liquid F flows downwards by gravity via the liquid supply line 620 into a module reservoir 260 (not illustrated here) of the sensor cleaning module 200.

The further sensor cleaning module 200′ is arranged above the windscreen wiper cleaning tank 410, so that a pump 610 for conveying the cleaning liquid into another module reservoir 260′ (not illustrated here) of the further sensor cleaning module 200′ is arranged in a further liquid supply line 620′, in particular if the further sensor cleaning module 200′ cannot suck in the water itself, or if the further sensor cleaning module 200′ itself does not have an electric pump or in order to support the function of a pump mechanism of the further sensor cleaning module 200′.

The two sensor cleaning modules 200, 200′ are supplied with compressed air DL in a known manner by a compressed air source 600 in the form of compressor 600 and are signal conductively connected via respective module control units 210, 210′ to each other and to a vehicle controller 1020.

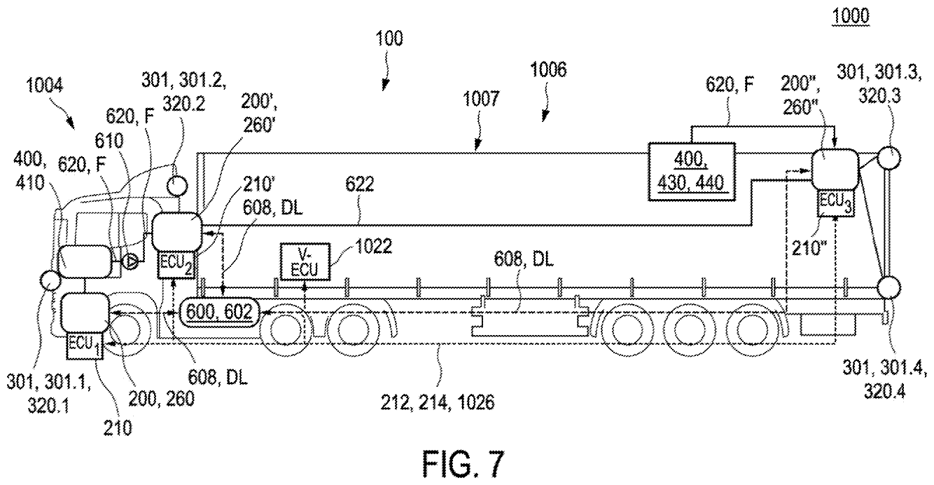

FIG. 7 shows a combination of a vehicle 1000, which has a trailer 1006 in addition to the commercial vehicle 1004 already shown in FIG. 6. The sensor cleaning system 100 is thus extended by the components arranged in the trailer 1006, in particular a still further sensor cleaning module 200″. That still further sensor cleaning module 200″ serves to supply a cluster of cleaning nozzles 320 arranged in the rear area of the trailer 1006, namely a third cleaning nozzle 320.3 for cleaning a third sensor 301.3 and a fourth cleaning nozzle 320.4 for cleaning a fourth sensor 301.4. The still further sensor cleaning module 200″ has a still further module control unit 210″, which is signal conductively connected to the vehicle controller 1022 and the further sensor cleaning modules 200, 200′ via a module communication line 214, which is formed in particular by a vehicle bus 1026.

The further sensor cleaning module 200″ is fluid conductively connected via a liquid supply line 620 to a liquid source 400. The liquid source 400 may be in the form of a rain collection device 430, which can in particular advantageously use a relatively large roof surface 1007 of the trailer 1006 for collecting rainwater to provide the rainwater as cleaning liquid F to the still further sensor cleaning module 200″ and in particular to store it in a still further module reservoir 260″ of the still further sensor cleaning module 200″. Also, the rain collection device 430 can be alternatively or additionally configured to collect spray water on the tires. A rain collection device 430 may in particular have a filter or a similar cleaning means for cleaning the cleaning liquid F.

Alternatively or additionally, a liquid source 400 may be in the form of a cooling system 440, which is primarily used to cool the goods transported in the trailer 1006, in particular food, and produces condensed as a product during operation. This condensed water can be collected and made available to the still further sensor cleaning module 200″ as cleaning liquid F.

Optionally, the individual sensor cleaning modules 200, 200′, 200″ can be fluid conductively connected to each other via an exchange line 622. In particular, as illustrated here, the further sensor cleaning module 200′ and the still further sensor cleaning module 200″ can be fluid conductively connected to each other via an exchange line 622, in particular to advantageously provide the other sensor cleaning modules, in particular the further sensor cleaning module 200′, with the cleaning liquid F obtained via the still further sensor cleaning module 200″ via the rain collection device 430 and/or via the cooling system 440.

FIG. 8 schematically shows a configuration of a sensor cleaning module 200 with a module housing 290, which is in the form of a valve cartridge housing 292. A valve cartridge housing 292 offers the advantage of a standard component, which is used in other areas of pneumatic or hydraulic or fluidic systems in vehicles and is therefore available cost-effectively. In the present case, the housing 290 in the form of the valve cartridge housing 292 has three valve inserts 294, namely a first valve insert 294.1, a second valve insert 294.2 and a third valve insert 294.3. In each valve insert 294, a switching valve 360 in the form of a cartridge valve 336 is arranged, which in the present case has a valve body 346 movable axially in the valve insert 294, wherein the valve body 346 can be selectively moved by a magnetic armature 348. For this purpose, each magnetic armature 348 is signal conductively connected to the module control unit 210—not illustrated here. The valve body 346 of each switching valve 360 has a first valve chamber 346A and a second valve chamber 346B.

A switching valve 360, if it is in the form of a 2/2-way valve as shown here, may be switched into an open position SO or a closed position SG depending on the position of the valve body 346. This is explained in the present case using the first switching valve 362. In a closed position SG, a first port 362.1 and a second port 362.2 are pneumatically separated from a third port 362.3 and a fourth port 362.4, but the first and second ports 362.1, 362.2 are pneumatically connected to each other, and the third and fourth ports 362.3, 362.4 are pneumatically connected to each other. In the present embodiment, the pneumatic separation in all switching valves 362, 364, 366 between the first and second ports 362.1, 362.2 on one side and the third and fourth ports 362.3, 362.4 on the other side is only one-sided, that is, such that in the closed position a medium can flow from the third and fourth ports 362.3, 362.4 towards the first and second ports 362.1 and 362.2. This is due to the fact that the valve bodies are standard components, having a sealing ring 342 with a one-sided blocking sealing lip on the valve body 346 between the first valve chamber 346A and the second valve chamber 346B. This circumstance can be countered by the fact that a check valve, here in the form of a first check valve 372, is provided for each switching valve at one of the ports at least, here in the first switching valve 362 at the first port 362.1. The first check valve 372 prevents a flow from the third and fourth ports 362.3, 362.4 towards the first and second ports 362.1, 362.2 with the first switching valve 362 in the closed position SG. In a similar manner, two-sided sealing of the second switching valve 364 is ensured by a second check valve 374 and a third check valve 376, and of the third switching valve 366 by a fourth check valve 378.

With a switching valve 360, here the switching valve 362, in an open position SO, all ports 362.1, 362.2, 362.3, 362.4 are pneumatically connected to each other.

The first switching valve 362 and the second switching valve 364 essentially form the valve unit 270 of the sensor cleaning module 200. When the first switching valve 362 is in its open position SO, an air pressure applied to the module compressed air port 272 is forwarded to the third and fourth ports 362.3, 362.4. As a result, the compressed air DL at the fourth port 362.4 is fed in the form of a compressed air control signal DSS to an air chamber 228.1 of a piston 228 of the pump mechanism 220. Supplying the air chamber 228.1 with the compressed air control signal DSS results in an expansion of the air chamber 228.1, which leads to a displacement of an axially movable plunger 228.3 of the piston 228 and—associated with this—to a contraction of a liquid chamber 228.2 of the piston 228. As a result, a fluid flow of cleaning liquid F contained in the liquid chamber 228.2 is created past a suction pressure check valve 350 to a cleaning nozzle 320. In accordance with the compressed air control signal DSS, the cleaning liquid F is output as a liquid cleaning pulse FRI from the cleaning nozzle 320 towards a sensor surface 300, which is not illustrated here, for cleaning. The fourth check valve 368 prevents the cleaning liquid F from flowing from a second port 366.2 of the third switching valve 366 to a first port 366.1 of the third switching valve 366. Due to the only one-sided blocking property of the sealing ring 342 described above, such a flow would otherwise occur even with the third switching valve 366 in a closed state SG.

The air pressure applied to the module compressed air port 272 is also provided at the third port 362.3 of the first switching valve 362 with the first switching valve 362 in the open position SO. From there, the compressed air passes via the second check valve 374 to a first port 364.1 of the second switching valve 364. With the second switching valve 364 in an open position S, the first port 364.1 is pneumatically connected to a second port 364.2 of the second switching valve 364, so that the compressed air DL applied to the module compressed air port 272 is forwarded from the second port 364.2 of the second switching valve 264 past the third check valve 376 and a cleaning compressed air port 274 in the form of a compressed air cleaning pulse DRI to the cleaning nozzle 320 for cleaning the sensor surface 300.

In this way, by suitably switching the first switching valve 362 and the second switching valve 364, selective control of a liquid cleaning pulse FRI and/or a compressed air cleaning pulse DRI at the cleaning nozzle 320 can be carried out. In particular, pulse sequences or medium sequences can be delivered in a controlled manner to achieve a desired cleaning effect.

For refilling the liquid chamber 228.2 of the piston 228, in particular if the first switching valve 362 is in its closed position SG and the second switching valve 364 is in its open position SO, the third switching valve 366 may be switched to its open position SO. In this position, the air in the air chamber 228.1 can escape via the fourth port 362.4 and the third port 362.3 of the first switching valve 362 and via the second check valve 374, and via the opened second switching valve 364 to the cleaning nozzle 320. At the same time, a return spring 228.4 ensures that the plunger 228.3 is moved back, which contracts the air chamber 228.1 and expands the liquid chamber 228.2. By expanding the liquid chamber 228.2, a vacuum is created, which—with an open third switching valve 366—leads to the suction of cleaning liquid F from a module reservoir 260, with which the liquid chamber 228.2 is accordingly filled. The intake pressure check valve 350 blocks the connection to the cleaning nozzle 320 in order to avoid a drop in the negative pressure and to enable the refilling of the liquid, 228.2.

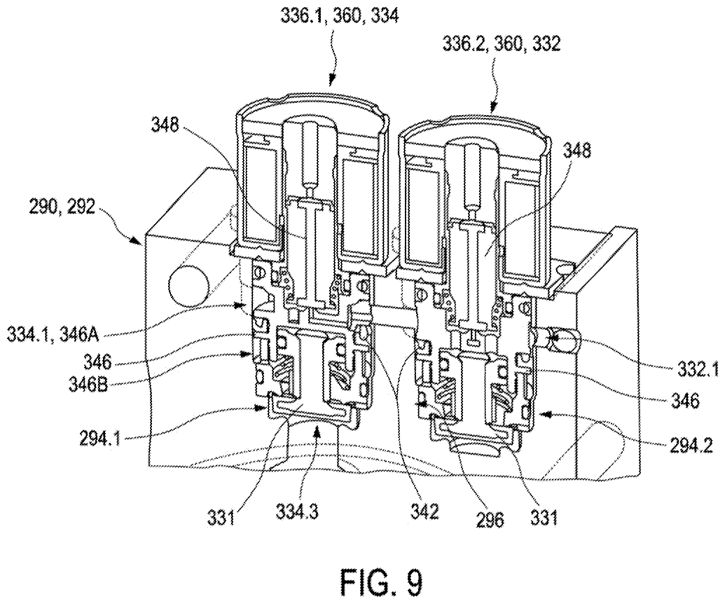

FIG. 9 shows a detail of a module housing 290 in the form of valve cartridge housing 292 in a sectional illustration in which two switching valves 360 in the form of cartridge valves 336 can be seen, namely a first cartridge valve 336.1 and a second cartridge valve 336.2. The cartridge valves 336 are advantageously configured identically with a magnetic armature 348, a valve body 346 and a valve piston 331 movably held within the valve body 346. The valve body 346 is configured to form pressure chambers, in particular a first pressure chamber 346A and a second pressure chamber 346B, in each case by sealing rings arranged around the valve body 346 and sealing against an inner wall 296 of the valve insert 294, in particular a sealing ring 342.

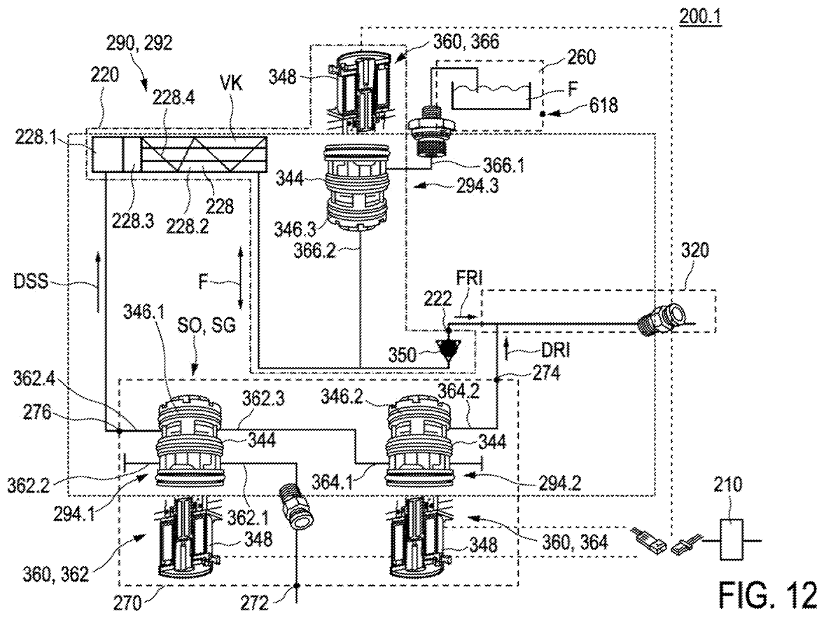

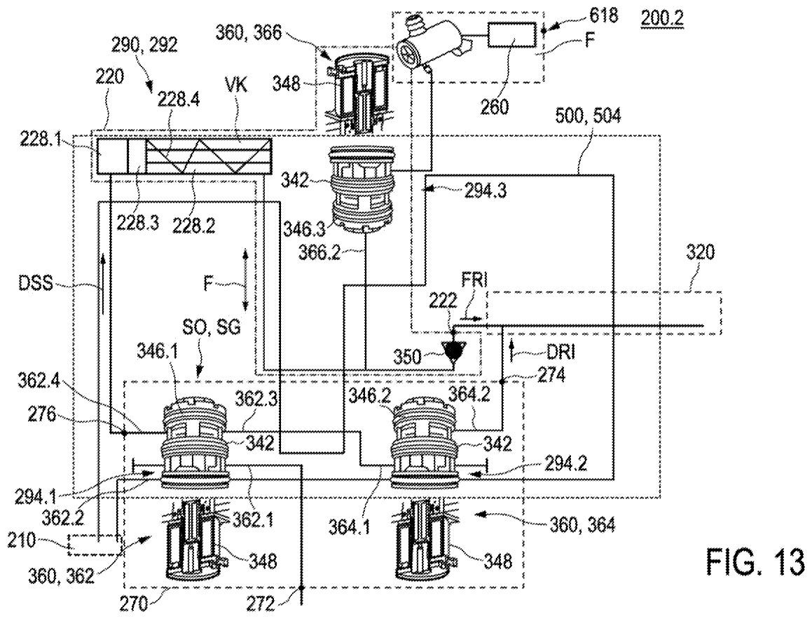

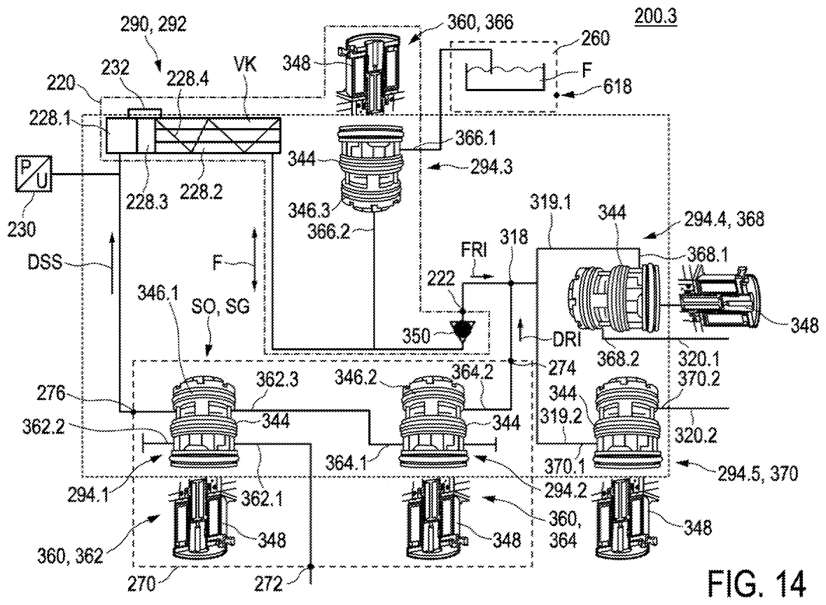

The valve cartridge housing 292 is in particular in the form of a block, for example of plastic or aluminum, and is provided with valve inserts 294, which are essentially in the form of cylindrical openings. In the present case, the first cartridge valve 336.1 is arranged in a first valve insert 294.1 and the second cartridge valve 336.2 in a second valve insert 294.2. By ducts and similar air and/or fluidic connections between the valve inserts 290, 290.1, 290.2, the switching valves can be connected to each other and/or to external components via their ports 332.1, 332.2, 334.1, 334.2, 334.3, in particular for the structural implementation of the sensor cleaning modules 200, 200.1, 200.1, 200.2 shown in the circuit diagrams of FIG. 8, FIG. 12, FIG. 13, FIG. 14.

The first cartridge valve 336.1 is in the form of a 3/2-way valve 334, because the second valve insert 294.2 has a third port 334.3 through an additional, compressed air conducting opening below the valve body 346.1 of the first cartridge valve 336.1—in addition to a first port 334.1 and a second port 334.2 which is not visible in this sectional illustration.

In the second valve insert 294.2 such an additional opening below a valve body 346.2 of the second cartridge valve 336.2 is not provided, which is why the second cartridge valve 336.2 has no third port in addition to a first port 332.1 and a second port 332.2 which is not visible in this sectional illustration as with the first cartridge valve 336.1.

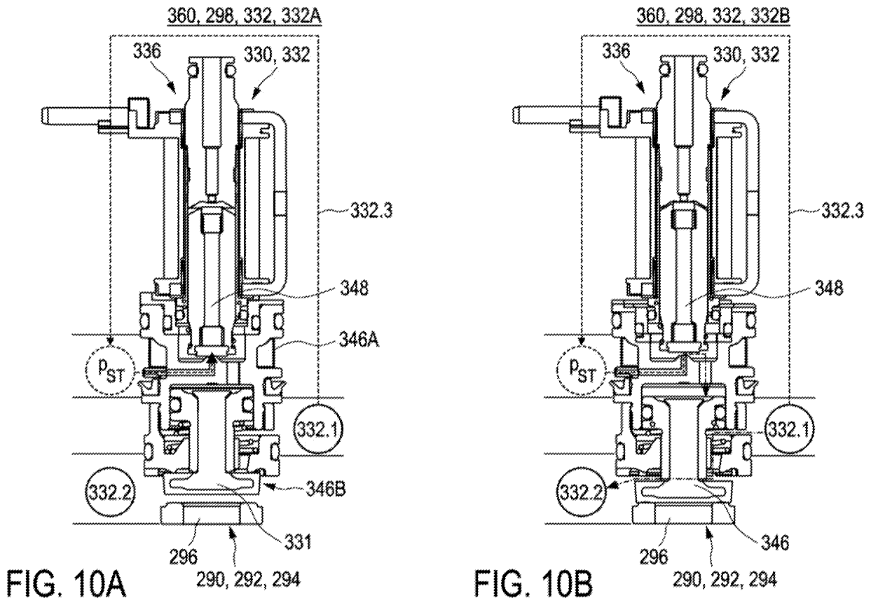

FIG. 10A and FIG. 10B show a preferred switching valve 360 in the form of a 2/2-way valve 332 in a sectional view. The embodiment shown here is a cartridge valve 336 in the form of a solenoid valve, which can be switched by a corresponding electronic activation—and optionally here also by a control pressure PST. The cartridge valve 336 is configured in particular for installation in a, in particular standardized, valve cartridge housing 292, which can be used as a module housing 290 for a sensor cleaning module 200—or parts of the sensor cleaning module 200.

The control pressure PST can be provided via a control pressure line 332.3 illustrated here schematically, wherein the control pressure line 332.3 is pneumatically connected in particular to the first port 332.1 of the 2/2-way valve 332. The cartridge valve 336 has a valve body 346 with a first valve chamber 346A and a second valve chamber 346B, which can be connected or disconnected by a valve piston 331 that can be moved relative to the valve body 346. In a closed position 332A illustrated in FIG. 10A, the first port 332.1 and the second port 332.2 of the 2/2-way valve 332 are pneumatically separated by a valve piston 331.

In an open position 332B shown in FIG. 10B, by energizing a magnetic armature 348 and a resulting axial movement of the magnetic armature 348, the valve piston 331 is pressurized with the control pressure PST, which results in an axial movement of the valve piston 331 towards a valve seat 298 of the 2/2-way valve 332, wherein the valve seat 298 is formed in the valve seat 294 by a part of the module housing. As a result of the axial movement of the valve piston 331, the first port 332.1 is pneumatically connected to the second port 332.2.

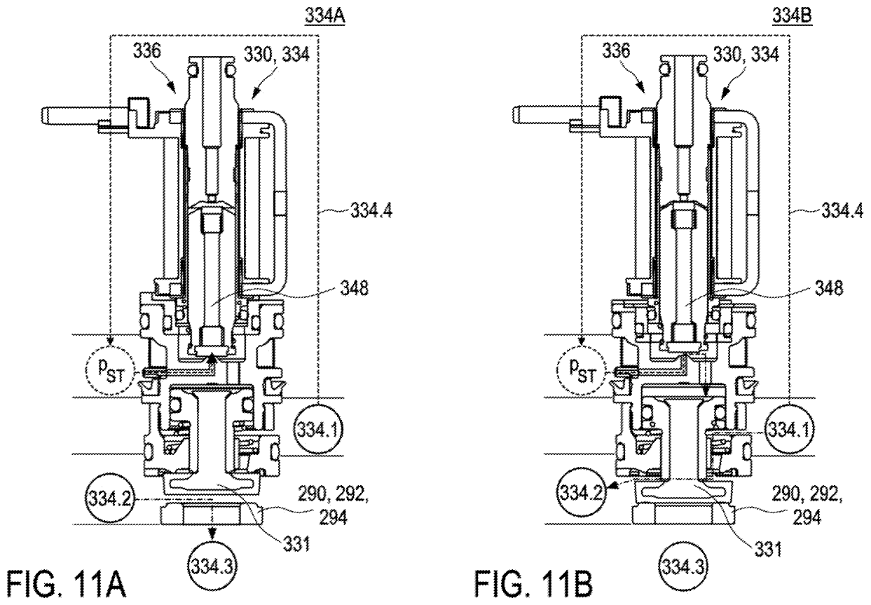

In FIG. 11A and FIG. 11B a further preferred switching valve 360 in the form of a 3/2-way valve 334 is illustrated. In particular, the 3/2-way valve 334, as the 2/2-way valve 332 shown in FIG. 10A and FIG. 10B, is in the form of an in particular identical cartridge valve 336 and can be used in the present case as a 3/2-way valve 334—by the additional use of a port arranged in the valve seat 298 as a third port 334.3. The valve seat 298—and thus the third port 334.3—is arranged below the valve body 346 and the valve piston 331 in the valve insert 294.

In the closed position 334A of the 3/2-way valve 334 shown in FIG. 11A, the magnetic armature 348 is in its closed position, which means that the control pressure PST cannot act on the valve piston 331. In this closed position 334A, the first port 334.1 is blocked and the second port 334.2 is pneumatically connected to the third port 334.3. Analogous to the open position 332B of the 2/2-way valve 332 shown in FIG. 10B, in an open position 334B of the 3/2-way valve 334 shown in FIG. 11B, the magnetic armature 348 is moved upwards by energization, whereby the control pressure PST can act on the valve piston 331 and moves it axially towards the valve seat 298. As a result, the third port 334.3 is blocked and the first port 334.1 is pneumatically connected to the second port 334.2 of the 3/2-way valve 334.

In alternative embodiments, other types of valves known to those skilled in the art can also be used, for example, a directly switching solenoid valve without the use of a control pressure. With a direct-switching solenoid valve, the valve piston is moved directly by the energization of a solenoid anchor, which means that the valve piston does not need to be pressurized with a control pressure.

In FIG. 12, a further embodiment of a sensor cleaning module 200.1 is illustrated, which, in contrast to the embodiment shown in FIG. 8, has a valve body 346 which instead of the sealing ring 342 only sealing on one side has an O-ring sealing on both sides, in particular with a round cross-section. Due to the sealing effect of the O-ring 344 on both sides, in contrast to the embodiment shown in FIG. 8, the first check valve 372, the second check valve 374, the third check valve 376 and the fourth check valve 378 can be dispensed with, whereby the configuration of the sensor cleaning module 200.1 is advantageously simplified. Furthermore, FIG. 12 illustrates by way of example a module control unit 210, in particular for activating the switching valves 362, 364, 366. The illustration of the module control unit 210 was omitted in the other embodiments shown for reasons of clarity.

In FIG. 13, a further embodiment of a sensor cleaning module 200.2 is illustrated, which in addition to the sensor cleaning module 200.1 illustrated in FIG. 12 has a heating device 500 in the form of a heating wire 504. Such a heating wire can also be used in all other embodiments of sensor modules 200 shown. The heating wire 504 is advantageously guided through the housing 290, in particular the valve cartridge housing 292, in such a way that all essential components, in particular the switching valves 362, 364, 366 and the pump mechanism 220, are heated by the heating wire 504. The heating wire is preferably connected to the module control unit 210 for power supply and control. Alternatively or additionally, a relay can be provided for the supply and control of the heating wire 504. With a heating device 500, freezing of the sensor cleaning module 200.2 at low temperatures can be advantageously avoided and/or heating of the cleaning liquid F to improve the cleaning performance can be achieved.

FIG. 14 illustrates a further embodiment of a sensor cleaning module 200.3, which in addition to the sensor cleaning module 200.1 illustrated in FIG. 12 has two further switching valves, namely a fourth switching valve 368 and a fifth switching valve 370. For this purpose, the housing 290 in the form of a valve cartridge housing 292 has a fourth valve insert 294.4 for the fourth switching valve 368, and a fifth valve insert 294.5 for the fifth switching valve 370. The sensor cleaning module 200.3 shown in FIG. 14 is configured for supplying several cleaning nozzles 320.1, 320.2. The fourth and fifth switching valves 368, 370 can advantageously supply different cleaning nozzles 320.1, 320.2.

A media combiner 318, which merges the cleaning liquid port 222 and the cleaning compressed air port 274, is arranged before a division into a first nozzle branch line 319.1 and a second nozzle branch line 319.2 in the flow direction of the cleaning pulses FRI, DRI. The fourth switching valve 368 is arranged in the first nozzle branch line 319.1, and the second switching valve 370 is arranged in the second nozzle branch line 319.2. By switching the fourth switching valve 368 into an open position SO, a fluid conductive connection between a first port 368.1 and a second port 368.2 of the fourth switching valve 368 can be established to connect the first nozzle branch line 319.1 to a first cleaning nozzle 320.1 and accordingly to direct cleaning pulses FRI, DRI to the first cleaning nozzle 320.1. Instead of just a first cleaning nozzle 320.1, several cleaning nozzles 320 can of course also be connected to the second port 368.2 of the fourth switching valve 368.

In an analogous manner, by switching the fifth switching valve 370 into an open position SO, a fluid conductive connection between a first port 370.1 and a second port 370.2 of the fifth switching valve 370 can be established in order to connect the second nozzle branch line 319.2 to a second cleaning nozzle 320.2 and accordingly to direct cleaning pulses FRI, DRI to the second cleaning nozzle 320.2. Instead of just a second cleaning nozzle 320.2, several cleaning nozzles 320 can of course also be connected to the second port 370.2 of the fifth switching valve 370.

Furthermore, a sensor cleaning module 200 in all embodiments, as shown here by way of example in the sensor cleaning module 200.3, can have a pressure sensor 230 and/or a position sensor 232 to measure the pressure build-up in the pump mechanism 220, in particular in the piston 228, and to switch the switching valves depending on this pressure or depending on the position of the plunger 228. In embodiments with a pressure sensor 230 and/or a position sensor 232, in particular, the position of the plunger 228.3 can be set variably using control technology. In particular, in such developments, the duration and intensity of the liquid cleaning pulse FRI and/or the compressed air cleaning pulse DRI can be set variably, in particular as required. For this purpose, the pressure sensor 230 and/or the position sensor 232 is signal conductively connected to the module control unit 210 (not illustrated here).

It is understood that the foregoing description is that of the preferred embodiments of the invention and that various changes and modifications may be made thereto without departing from the spirit and scope of the invention as defined in the appended claims.

### REFERENCE CHARACTER LIST (PART OF THE DESCRIPTION)

100 sensor cleaning system
200 sensor cleaning module
200′ additional sensor cleaning module
200″ additional sensor cleaning module
200.1-3 other embodiments of a sensor cleaning module
210 module control unit
210′ additional module control unit
210″ yet another module control unit
211 device control unit
212 module control line
213 device control line
213.1, 213.2 first, second device control lines
214 module communication line
220 pump mechanism
222 cleaning fluid port
226 nozzle liquid line
228 piston
228.1 air chamber of the piston
228.2 liquid chamber of the piston
228.3 plunger
228.4 return spring
230 pressure sensor
232 position sensor
260 module reservoir
260′ additional module reservoir
260″ additional module reservoir
264 storage line
270 valve unit
272 module compressed air port
274 cleaning compressed air port
276 control compressed air port
278 nozzle compressed air line
280 module compressed air reservoir
290 module housing
292 valve cartridge housing
294 valve insert
294.1-5 first to fifth valve inserts
296 inner wall of the valve insert
298 valve seat of the valve insert
300 sensor surface
301 sensor
318 media merging
319.1, 319.2 first, second nozzle branch lines
320 cleaning nozzle
331 valve piston
332 2/2-way valve
332.1 first connection of the 2/2-way valve
332.2 second connection of the 2/2-way valve
332.3 control line of the 2/2-way valve
332A closed position of the 2/2-way valve
332B open position of the 2/2-way valve
334 3/2-way valve
334.1 first connection of the 3/2-way valve
334.2 second connection of the 3/2-way valve
334.3 third connection of the 3/2-way valve
334.4 control line of the 3/2-way valve
334A closed position of the 3/2-Wegeventils
334B open position of the 3/2-Wegeventils
336 cartridge valve
336.1, 336.2 first, second cartridge valves
342 sealing ring
344 O-Ring
346 valve body
346A, 346B first and second valve chambers
348 magnetic armature
350 intake pressure check valve
360 switching valve
362 first switching valve
362.1-4 first to fourth connections of the first switching valve
364 second switching valve
364.1-2 first, second connections of the second switching valve
366 third switching valve
366.1-2 first, second connections of the third switching valve
368 fourth switching valve
368.1-2 first, second connections of the fourth switching valve
370 fine switching valve
370.1-2 first, second connections of the fifth switching valve
372 first check valve
374 second check valve
376 third check valve
378 fourth check valve
400 liquid source
410 windscreen wiper liquid tank
420 fuel cell
430 rain collection device
440 cooling system
450 air dryer
500 heater
502 heat exchanger
510 waste heat
520 heat source
522 combustion engine
524 exhaust system
602 control line
600 compressed air source
602 compressor
604 central compressed air reservoir
606 compressed air supply system
608 compressed air line
610 pump
618 module liquid port
620 liquid feed line
622 exchange line
1000 vehicle
1002 PKW
1004 command vehicle
1006 trailer
1007 roof surface of the trailer
1020 vehicle control unit
1022 control signal
1024 central control unit
1026 vehicle bus
1030 front area of the vehicle
1032 first sensor cluster
1040 rear area of the vehicle
1042 second sensor cluster
LA line length
DL compressed air
DRI compressed air cleaning pulse
DSS compressed air control signal
F cleaning liquid
FRI liquid cleaning pulse
LA line distance
PST control pressure
S control signal
SG closed position of the switching valve
SO Open position of the switching valve
SV priority ranking
VF capacity of the module reservoir
VK piston volume

1. A sensor cleaning system for a vehicle, the sensor cleaning system comprising:
at least one sensor cleaning module having a valve unit;
said valve unit being configured to receive compressed air via a module compressed air port and to selectively output a compressed air cleaning pulse via a cleaning compressed air port;
said at least one sensor cleaning module having a module reservoir and a pump mechanism;
said module reservoir being configured to receive and store a cleaning liquid provided via a module liquid port;
said module reservoir being connected to said pump mechanism for fluid transfer; and,
said pump mechanism being configured to provide the cleaning liquid in a form of a liquid cleaning pulse at a cleaning fluid port in dependence upon a control signal.

2. The sensor cleaning system of claim 1, wherein said pump mechanism is operated by compressed air; the control signal is in the form of a compressed air control signal; and, said valve unit is configured for the selective output of the compressed air control signal via a control compressed air port.

3. The sensor cleaning system of claim 1, wherein at least one of
said sensor cleaning module has a module control unit configured to control said valve unit; and,
said sensor cleaning system has a device control unit configured to control said valve unit of said at least one sensor cleaning module.

4. The sensor cleaning system of claim 1 further comprising at least one cleaning nozzle connected to the sensor cleaning module for at least one of air transfer and fluid transfer; and, said at least one cleaning nozzle being configured to apply at least one of the liquid cleaning pulse and a compressed air cleaning pulse to a sensor surface.

5. The sensor cleaning system of claim 1 further comprising:
at least one further sensor cleaning module;
wherein said sensor cleaning module and said at least one further sensor cleaning module are connected bidirectionally via at least one of an exchange line for fluid transfer and a control line for signal transfer.

6. The sensor cleaning system of claim 5, wherein:
said sensor cleaning module is assigned to a first sensor cluster with a number of cleaning nozzles located together locally for at least one sensor; and,
said at least one further sensor cleaning module is further assigned to a second cluster with a number of cleaning nozzles located together locally for at least one sensor.

7. The sensor cleaning system of claim 6, wherein each of said number of cleaning nozzles are for one sensor.

8. The sensor cleaning system of claim 1, wherein said module reservoir is connected for fluid transfer to at least one liquid source; and, said sensor cleaning module is lower than said at least one liquid source.

9. The sensor cleaning system of claim 8, wherein said sensor cleaning module is lower than said at least one liquid source.

10. The sensor cleaning system of claim 8 further comprising a pump configured to convey the cleaning liquid, wherein said pump is arranged in a liquid supply line connecting the sensor cleaning module to said at least one liquid source for fluid transfer or in an exchange line.

11. The sensor cleaning system of claim 1, wherein at least two cleaning nozzles are assigned to said at least one sensor cleaning module.

12. The sensor cleaning system of claim 1, wherein a cleaning nozzle is arranged separately from said at least one sensor cleaning module.

13. The sensor cleaning system of claim 11, wherein a line length between said at least one sensor cleaning module and at least one of said cleaning nozzles assigned to said at least one sensor cleaning module is less than 80 cm.

14. The sensor cleaning system of claim 1, wherein said at least one sensor cleaning module has a module compressed air reservoir configured to receive and locally store the compressed air provided via said module compressed air port.

15. The sensor cleaning system of claim 1, wherein said module reservoir of said at least one sensor cleaning module has a capacity between 250 milliliters and 3000 milliliters.

16. The sensor cleaning system of claim 1, wherein said sensor cleaning module is at least one of arranged and configured to use waste heat of a heat source of the vehicle.

17. The sensor cleaning system of claim 16 further comprising a heating device configured to absorb heat from the heat source of the vehicle.

18. The sensor cleaning system of claim 1, wherein said at least one sensor cleaning module has a module housing surrounding said at least one sensor cleaning module.

19. The sensor cleaning module of claim 18, wherein said module housing is formed from a valve cartridge housing and has a plurality of valve inserts including a first valve insert, a second valve insert and a third valve insert; and, each of said plurality of valve inserts is assigned a switching valve in the form of a cartridge valve arranged in a corresponding one of said plurality of valve inserts.

20. The sensor cleaning system of claim 19, wherein said plurality of valve inserts have a hollow cylindrical configuration and said switching valves each have a valve body with a first and a second axially adjacent valve chamber; said first axially adjacent valve chamber and said second axially adjacent valve chamber are pneumatically separated at least in one flow direction by a sealing ring bearing against an inner wall of a corresponding one of said plurality of valve inserts in a pressure-tight manner.

21. The sensor cleaning system of claim 20, wherein said sealing ring is an O-ring blocking on both sides.

22. The sensor cleaning system of claim 3, wherein said valve unit is controlled in dependence upon a control signal provided by a vehicle control unit of the vehicle.

23. The sensor cleaning system of claim 18, wherein said module housing is made of at least one of plastic, aluminum, and cast aluminum.

24. A vehicle comprising the sensor cleaning system of claim 1.

25. The vehicle of claim 24, wherein the vehicle is a passenger car, a trailer, or a commercial vehicle.
